(19) United States
(12) Patent Application Publication
(10) Pub. No.: US 2025/0264275 A1
(43) Pub. Date: Aug. 21, 2025

(54) LASER DRIVEN COMMERCIAL DRYING

(71) Applicant: Worcester Polytechnic Institute, Worcester, MA (US)

(72) Inventors: Jamal S. Yagoobi, Hopkinton, MA (US); Itamar Harris, Worcester, MA (US)

(21) Appl. No.: 19/054,866

(22) Filed: Feb. 16, 2025

Related U.S. Application Data
(60) Provisional application No. 63/554,237, filed on Feb. 16, 2024.

(51) Int. Cl. F26B 3/30; F26B 15/18; F26B 25/22; G02B 19/00; G02B 27/09

(52) U.S. Cl. CPC F26B 3/30; F26B 15/18; F26B 25/22; G02B 19/0009; G02B 19/0047; G02B 27/0927

(57) ABSTRACT

A laser drying apparatus efficiently directs laser energy at a target media in an industrial environment. Typical industries include food production, continuous paper and sheet goods, and other suitable porous articles where moisture content is abated. A laser passes through a lens or beam shaping element for directing the laser energy incident upon the target media for drying. A beam-shaped form is preferable for even energy distribution over an area of the target media. Focused, beam shaped laser energy provides more efficient energy transfer to the target media over conventional radiant and/or convection heating. Electrical sources may be selected from environmentally favorable generation sources. The laser energy penetrates the target media to a depth greater than conventional heating methods, and may be combined with complementary heating and drying sources, such as convective air streams or radiated heating for receiving an aggregate drying energy by the target media.

### RELATED APPLICATIONS

This patent application claims the benefit under 35 U.S.C. § 119 (e) of U.S. Provisional Patent App. No. 63/554,237 filed Feb. 16, 2024, entitled “LASER DRIVEN COMMERCIAL DRYING,” incorporated herein by reference in entirety.

### STATEMENT OF FEDERALLY SPONSORED RESEARCH AND DEVELOPMENT

This invention was developed, at least in part, with U.S. Government support under contract No. 2113831, awarded by the National Science Foundation (NSF), and contract No. EE0011608, awarded by the Department of Energy (DOE). The Government has certain rights in the invention.

### BACKGROUND

Industrial drying facilitates commercial processes where moisture is beneficial or required to be removed from a process, manufactured good or environment. Food production, such as baking operations, and paper production are several industries where efficient drying is sought. Industrial drying consumes substantial energy in manufacturing. Drying is often performed by heating, typically from electricity and corresponding fossil fuels, either directly (e.g. gas) for combustion heat, or indirectly by electrical resistance heating from fossil fuel sourced electricity.

### SUMMARY

A laser drying apparatus efficiently directs laser energy at a continuous series of a target media in an industrial environment. Typical industries include food production, continuous sheet goods such as paper, textiles, pharmaceuticals, chemicals, and other suitable porous articles where moisture content is abated. A laser passes through a lens or beam shaping element for directing the energy in the form of light incident upon the target media for drying. A beam-shaped form is preferable for even energy distribution over an area of the target media. Focused, beam shaped laser energy provides more efficient energy transfer to the target media over conventional radiant and/or convection heating. Electrical sources may be selected from environmentally favorable generation sources. The laser energy penetrates the target media to a depth greater than conventional heating methods, and may be combined with complementary heating and drying sources, such as convective air streams or radiated heating for receiving an aggregate drying energy by the target media.

Configurations herein are based, in part, on the observation that industrial drying methods and devices are employed in industries where precise moisture content and/or removal is beneficial or needed for manufacturing activities, such as in food and baked goods, sheet materials such as paper and cardboard, and slurries of comingled liquid, solids and any suitable moist porous media. Unfortunately, conventional approaches to drying suffer from the shortcomings of incomplete drying, excessive energy use and prolonged drying times. Accordingly, configurations herein substantially overcome the shortcomings of conventional industrial drying approaches by providing a laser directed at a target media for drying and expelling moisture from the target media. Laser technology has not been substantially utilized in conventional commercial and domestic heating, baking and drying processes or appliances. The laser may be operated alone or in a complementary manner with a secondary drying media as the laser tends to penetrate the target media while complementary radiant, convection or direct contact drying methods dry the surface region first. A laser energy level is selected based on a total energy for a predetermined level of moisture removal. A combination of timing and a moving conveyor irradiates the target media for an irradiation interval at the selected energy level. A beam shaping lens or device focuses the irradiating laser beam for a more consistent “flat top” energy distribution, rather than a conventional Gaussian distribution. The laser drying may include multiple laser stations, each not necessarily operating under the same conditions. This is to meet the target moisture loss level and increase in throughout without negatively impacting the product quality.

In further detail, configurations herein disclose a system and method for drying a substrate by computing an energy quantity for drying a target media, and directing a laser at the target media. A focusing element focuses or refracts the laser over an area of the target media for uniform energy distribution, and a controller operates the laser for a predetermined interval based on the computed energy quantity and the area of the target media, whereby the target media receives laser energy for drying at an energy density resulting from the energy quantity imposed on the target media and an area of the target media, optionally during transport on a conveyor past the irradiating laser source. Further features include determining the location and corresponding operating conditions of single or multiple laser stations to yield an optimal final moisture content throughout the dried article without compromising product quality. Configurations herein include optimally integrating the laser technology into existing or next generation drying processes, thereby resulting in decreased energy consumption and increased throughout, without degrading the product quality.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views.

The drawings are not necessarily to scale, emphasis instead being placed upon illustrating the principles of the invention.

FIG. 1 is a context view of a laser environment suitable for use with configurations herein;

FIGS. 2A and 2B show an example configuration of laser based drying in the environment of FIG. 1;

FIG. 3 shows a flat-top beam or energy distribution profile of the laser as in FIGS. 1, 2A and 2B;

FIG. 4 shows a side view of a drying apparatus using the laser as in FIGS. 1-3, illustrating schematic, arbitrary locations of each drying technology for illustration purposes; and

FIGS. 5A-5B show an example of power distribution results using the laser of FIGS. 1-4.

### DETAILED DESCRIPTION

Configurations herein depict a system, method and apparatus for incorporating energy efficient laser based drying mediums into industrial environments. A laser implementation provides higher incident heat on the product surface which also penetrates into moist or almost dry porous media as well as slurries. This results in reduced energy consumption, higher throughout, and possibly better products. Further, the electrically operated laser moves towards a zero-carbon footprint when sourced from environmentally sound generation.

Industrial drying consumes approximately 12% of the total end-use energy used in manufacturing, corresponding to 1.2 quads annually in the U.S. The disclosed laser technology and the advanced sensor and process controls is projected to reduce the corresponding process heating energy consumption by at least 25 percent in baking ovens and by 10 percent in paper and pulp dryers with a favorable footprint.

Laser usage for heating, baking, drying applications in industries such as food and pulp, paper, chemicals, textile, pharma or for any suitable moist porous material. industry sectors is an emerging concept. A laser assisted process employs near infrared wavelengths to impart energy, but with three profound differences. (1) The laser is highly directable with 90% of the optical energy may be trained on the target, while other technologies including infrared emitters distribute heat and light in all directions. (2) For this reason, the laser only heats the target while the atmosphere and walls absorb little energy. (3) The laser is a single wavelength, which along with the cold nature of the laser oven, enables metrology such as FLIR (Forward Looking Infrared) cameras, Pyrometers or CCD (Charge Coupled Device) cameras to be positioned inside the oven will ensure precise process control.

An incident heat flux on the target with this proposed laser technology is projected to attain at least one order of magnitude greater than the corresponding convective heating in commercial baking ovens as well as the direct contact heating in paper making drying process. Furthermore, the incident energy generated by the laser will penetrate the product, significantly impacting the system energy efficiency. The laser heating may be of significant advantage in the falling drying rate zone of paper drying as well, where the moisture is mainly trapped within the pores of fibers (i.e., the bound water) since the energy penetrates the paper even at a low moisture content. Significant advantage for the disclosed approach include electrification, reduction of energy consumption, and reduction of process time, thus leading to an increase in throughput.

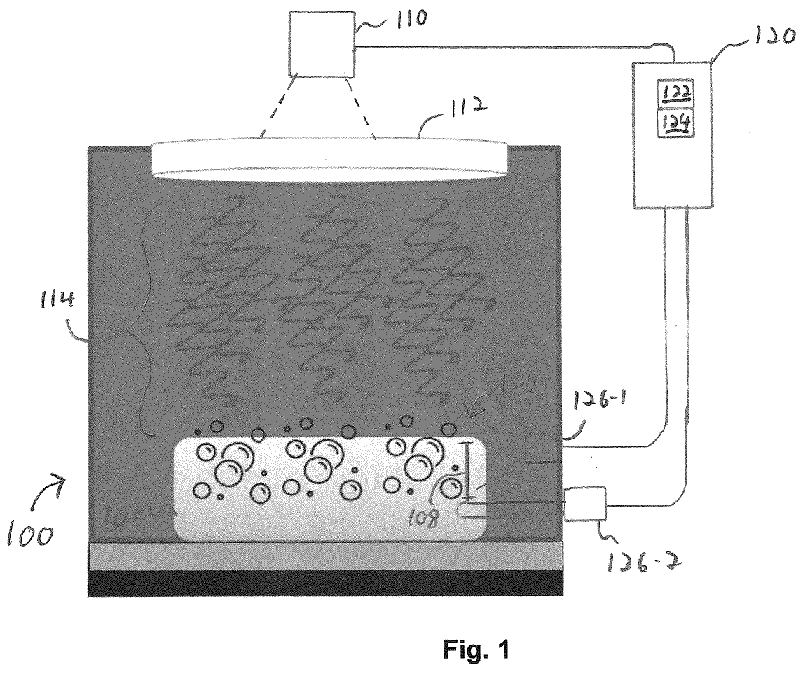

FIG. 1 is a context view of a laser environment 100 suitable for use with configurations herein. Referring to FIG. 1, a method for drying a substrate, product or food stock includes computing an energy quantity for drying a target media 101, and directing a laser 110 at the target media 101. A lens or beam forming element 112 focuses the laser irradiation t (laser beam) over an area 116 of the target media 101. A controller 120 powers and operates the laser 110 for a predetermined interval based on the computed energy quantity and the area 116 of the target media 101 receiving the energy from the laser irradiation 114. The target media 101 therefore receives the laser energy for drying at an energy density resulting from the energy quantity and area 116.

A timer 122 and power regulator 124 in the controller 120 adjust the timing and power level, respectively, of the laser 110. The laser directed at the target media 101 with favorable focus and direction from the beamforming element 112 results in a substantial portion of the laser energy being absorbed by the target media 101. The disclosed approach may results in greater than 90% of the laser 110 power 110 being absorbed by the target 101. It should be noted that power delivered by the controller 120 that is delivered to the laser 110 may be about 65 percent of the electric power that goes into 120 to generate the laser beam. The approximately 35% loss in 120 is picked up by a coolant/chiller, discussed further below, to maintain the temperature of the electronics at low level. If this 35% of primarily heat energy can be utilized by a complementary aspect, the whole laser process becomes very energy efficient.

The controller 120 receives a signal from a sensor 126-1 indicative of the laser energy received by the target media, such as an IR (infrared) thermometer or convection thermometer. An alternative sensor 126-2 (126 generally) may be inserted directly into or adjacent the target media 101, as in the case of a needle or probe inserted into a baked good or other food stock. Based on the feedback from the sensors 126, the controller 120 directs an energy level delivered by the laser 110. An advantage of laser energy for drying is penetration of the target media by the laser for a depth 108 up to several centimeters, while conventional approaches generally affect only the surface. This penetration depth depends on the medium. It can also exceed 1 cm depending on the medium radiation spectral properties as well as its physical properties such as porosity and permeability. Conversely, direct heating or convective heating do not penetrate into medium. They only heat the surface. IR penetrates at the most a mm or so depending on the product properties. However, microwave, using a different wavelength, may achieve substantial penetration.

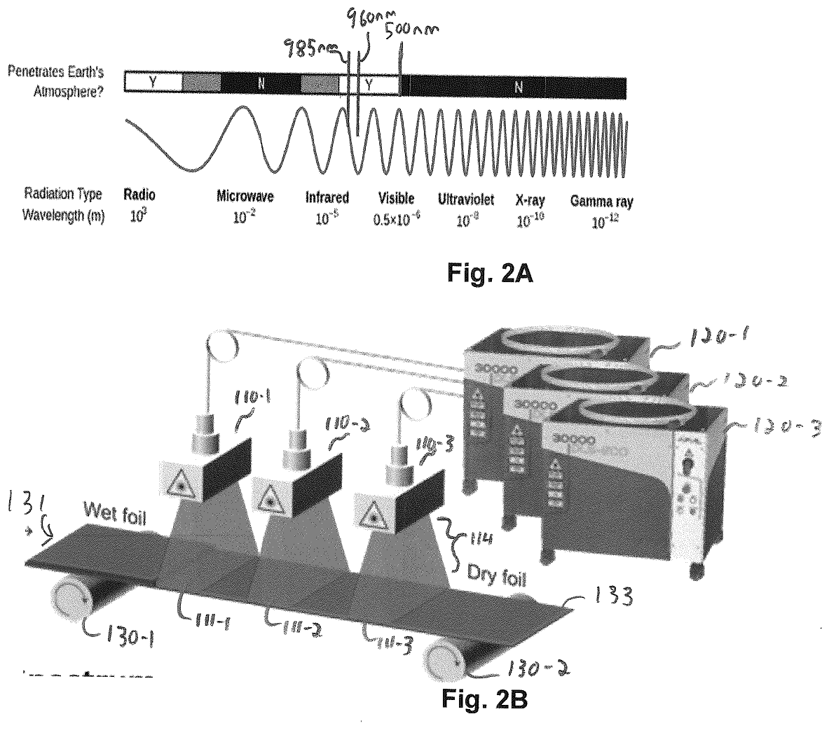

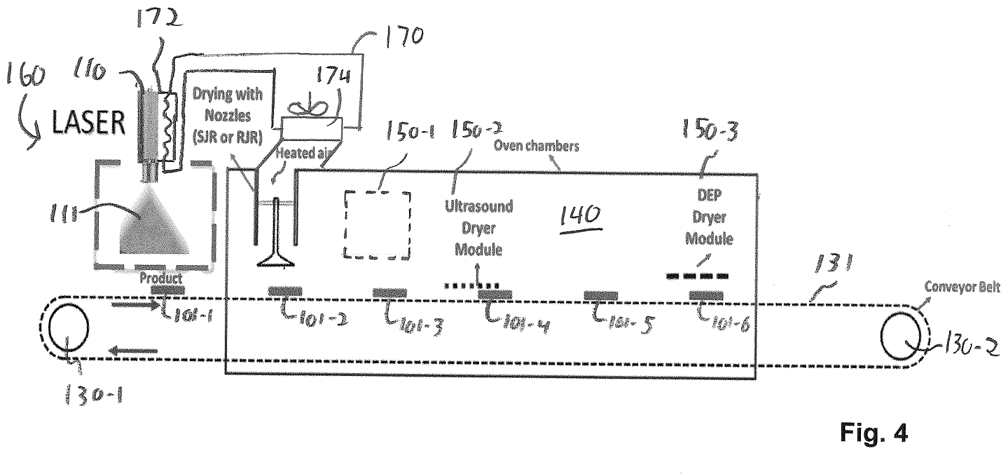

FIGS. 2A and 2B show an example configuration of laser based drying in the environment of FIG. 1. Referring to FIGS. 1-2B, a wavelength between 960-985 nm, near the visible spectrum (400-700 nm) and towards the IR a range achieves penetration for effectively drying at a depth up to several centimeters. Other suitable wavelengths could be employed. In operation, timing may include a conveyor 131 driven by rollers 130-1 . . . 130-2 operating at a speed for achieving an irradiation time. Multiple lasers 110-1 . . . 110-3 (110 generally) may be located for preceding a complementary drying source, discussed further below. The conveyor 131 advances the target media 101, such as a paper or pulp sheet 133, from a location for receiving laser energy to a complementary drying region for receiving energy from a complementary drying source. An aggregation of the received laser energy and the complementary drying source facilitates complete drying or moisture removal of the target media 101, discussed further below with respect to FIG. 4. Note that “drying” may not necessarily require complete moisture removal, but rather merely an attainment of a predetermined moisture level.

The choice of laser 110 may involve selecting a wavelength for the laser 110 based on an ability to penetrate the target media 101 at the selected wavelength. The use of the conveyor 131 allows for a stationary laser emitting the computed energy quantity based on a power of the laser and a duration of laser exposure as the conveyor draws the target media 101 through an irradiation zone 111-1 . . . 111-3 (111 generally) defined by the irradiated signals from each respective laser 110-1 . . . 110-3. Stationary or batch process for drying solely with the laser or combined with other technologies may also be implemented.

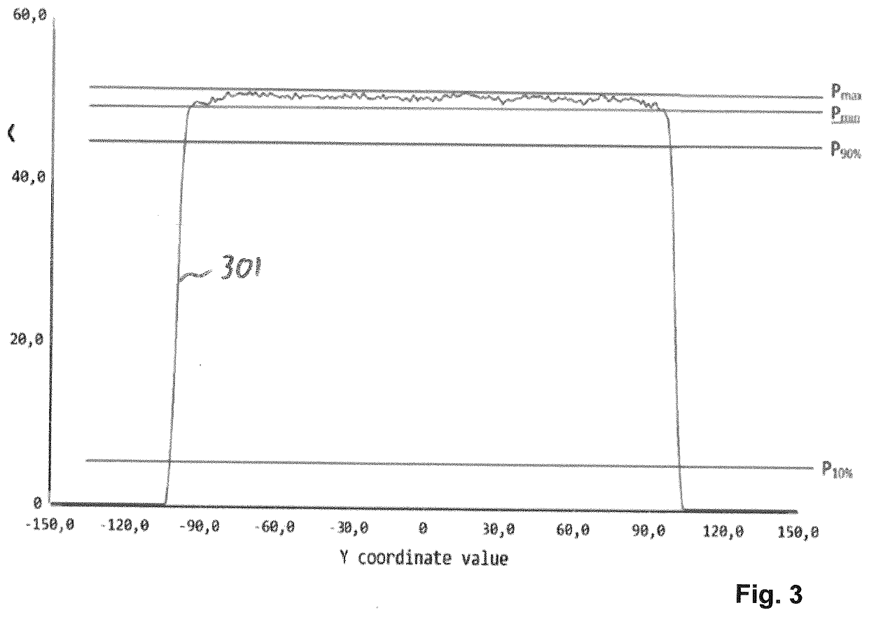

FIG. 3 shows a flat-top beam or energy distribution profile of the laser as in FIGS. 1, 2A and 2B. Referring to FIGS. 1-3, the laser 110 passes the irradiation beam 114 through the beamforming element 112, such as a lens or focusing structure. Conventional laser devices typically produce Gaussian or similar beam profiles, which distributes the laser energy over a surface in a “bell curve” distribution, that focuses less energy along the outer fringes and tends to concentrate energy centrally. Gaussian beams have a decrease in their symmetric irradiance profiles as the distance from the center of the laser beam cross-section increases. Flat top, or top hat, beams have a more constant irradiance profile through the cross-section of the laser beam. The beamforming element 112 therefore provides beam shaping the laser for flattening an irradiance profile of the laser. To overcome and more evenly distribute the laser energy, a flat-top beam can be obtained by refractive, diffractive and even absorptive elements, producing a flat top curve 301 as shown in FIG. 3. Among these methods, a refractive approach may have advantages such as high efficiency, simple structure and less wavelength-dependence, which are essential for high power lasers. A widely-used refractive laser beam shaper may consist of two separate aspherical lenses, a single lens or other suitable arrangement.

The focusing element 112 provides efficient transfer of energy to the target media 101 by avoiding excessive energy focused on the center of the irradiation area and mitigating wasteful irradiation of a surrounding area. The use of a conveyer 131 allows for operating the laser from a stationary location. Focusing or refracting may further comprise refracting a beam from the laser based on a percentage of a surface of the target media receiving the beam defining the irradiation zone 111. The focusing element may perform any suitable dispersion of the irradiative energy. Refraction and diffraction involve bending of light, refraction occurs when a laser beam changes direction as it moves between mediums with different densities, like entering water from air, while diffraction happens when a laser beam bends around the edge of an obstacle or through a narrow opening; essentially, refraction is a change in direction due to a change in medium, whereas diffraction is a spreading out of light waves around barriers or apertures.

The computed energy quantity is based on factors of the incident laser irradiation falling on the target media 101 as it passes through or resided in the radiation zone 111. Relevant factors include absorptivity, reflectivity, transmissivity and emissivity, and of course on energy that can be absorbed without any damage or degrading of the product defined by the target media 101. FIG. 4 shows a side view of a drying apparatus 160 using the laser as in FIGS. 1-3. Referring to FIGS. 1-4, the laser 110 may be attached adjacent to a complementary drying apparatus 140, where the complementary drying apparatus has a secondary drying medium 150-1 . . . 150-3 (150 generally), which may include for example one or more of forced air or convection, ultrasound, infrared emitter, radiofrequency, microwave, or dielectrophoretic (DEP) drying. The actual location of the secondary drying mediums 150 is illustrated schematically, and actual implemented locations of each drying technology may vary. The drying apparatus 160 operates a conveyor 131 driven by rollers 130, such that the conveyor 131 passes the irradiation zone 111 defined by the laser 110 prior to the target media 101-1 . . . 101-6 (101 generally) entering the complementary drying apparatus 140. The target media 101 is engaged with the conveyor 131 for passing through the irradiation zone 111 and the complementary drying apparatus 140 in sequence. The controller 120 computes a speed of the conveyor 131 based on an aggregate energy received for attaining a predetermined moisture content of the target media 101, where the aggregate energy includes the received energy quantity resulting from the laser 110 and an energy received from the drying mediums 150 within the drying apparatus 160. Thus, the conveyor 131 operates at a speed based on achieving a predetermined dryness following passage through the irradiation zone and the drying apparatus. A typical arrangement might involve operating the laser 110 for a duration or interval to dry a certain percentage of moisture content, and completing the remaining drying percentage, or to a predetermined moisture content, within the complementary drying apparatus 140.

The above approach directs the laser 110 for more efficient drying by directing a greater percentage of drying energy to reach the target media 101. As the laser 110 is electrical, electricity sourced from renewable sources mitigates environmental impact. A further enhancement is provided by redirecting cooling water from the laser back into the drying process or elsewhere in the industrial facility, such as for preheating of the product to be dried or HVAC (Heating/Ventilation/Air Conditioning) needs of the industrial facility.

The laser 110 generates substantial heat and may need a flow of water or cooling fluid to cool the laser by heat transfer. A coolant circuit 170 flows a coolant adjacent the laser 110 for cooling the laser and absorbs heat from the laser via a coil 172 or similar thermal communication.

The heat transferred to the coolant flows to a heat exchanger 174 disposed in a stream of convective air directed into the heating apparatus 160, and directing the air from the heat exchanger to the target media for recycling laser generated heat, directed to an HVAC exchanger for ambient building heat, or other suitable endothermic need.

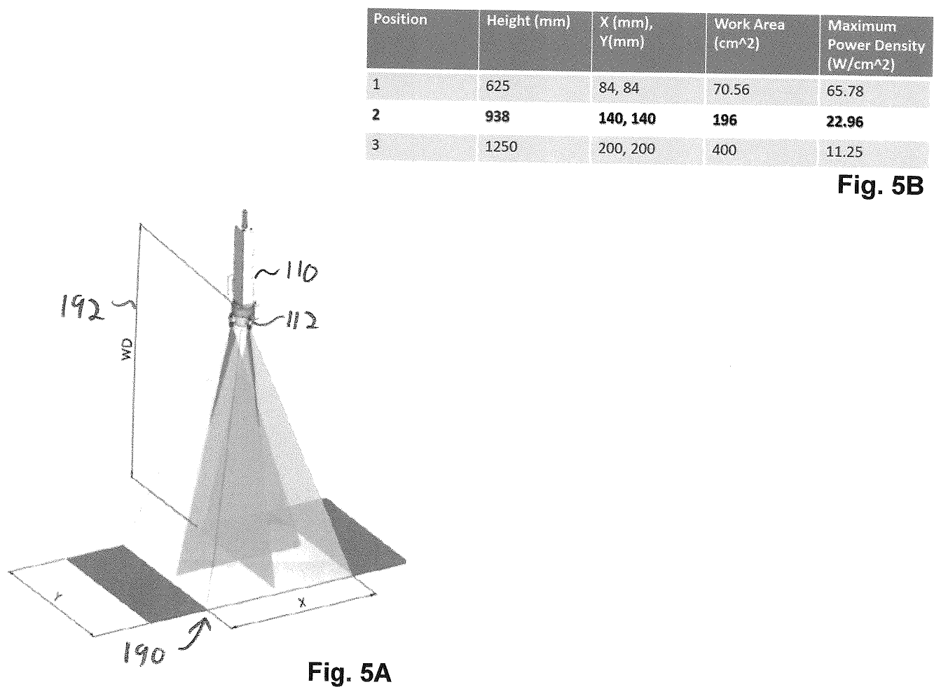

FIGS. 5A-5B show power distribution results using the laser of FIGS. 1-4. Referring to FIGS. 1 and 5A-5B, the laser 110 direct the irradiation zone 111 as a beam that falls on an area 190, defined generally by x,y coordinates or other area definition as directed by the beamforming element 112. FIG. 5B shows how a height 192 of the laser affects the area 190 and power density falling on the target media 101. It should be apparent that the area 190 resulting from the beamforming element 112 directs the area 190 in a correspondence with the target media 101 to avoid irradiation outside the target media. The laser 110 in a particular example may be operated at a power between 4.5-5.5 kW, however could easily be scaled tenfold to around 50 kW and beyond.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for drying a substrate, comprising:
computing an energy quantity for drying a target media;
directing a laser at the target media;
focusing the laser over an area of the target media; and
operating the laser for a predetermined interval, the predetermined interval based on the computed energy quantity and the area of the target media, whereby the target media receives laser energy for drying at an energy density resulting from the energy quantity and area.

2. The method of claim 1 further comprising:
locating the laser for preceding a complementary drying source;
advancing the target media from a location for receiving laser energy to a complementary drying region for receiving energy from the complementary drying source, an aggregation of the received laser energy and the complementary drying source completing drying of the target media.

3. The method of claim 1 wherein directing the laser at the target media results in at least 80% of energy of the laser being absorbed by the target media.

4. The method of claim 1 further comprising penetrating, by the laser, the target media for a depth of at least 1 cm.

5. The method of claim 1 further comprising:
selecting a wavelength for the laser based on an ability to penetrate the target media; and
operating the laser at the selected wavelength.

6. The method of claim 1 further comprising:
operating the laser from a stationary location, wherein focusing further comprises refracting a beam from the laser based on a percentage of a surface of the target media receiving the beam.

7. The method of claim 1 further comprising:
attaching the laser adjacent a complementary drying apparatus, the complementary drying apparatus having a secondary drying medium;
operating a conveyor, the conveyor passing through:
an irradiation zone defined by the laser; and
the drying apparatus;
the target media engaged with the conveyor for passing through the irradiation zone and the drying apparatus.

8. The method of claim 7 further comprising operating the conveyor at a speed based on achieving a predetermined dryness following passage through the irradiation zone and the drying apparatus.

9. The method of claim 7 further comprising:
computing the speed based on an aggregate energy received for attaining a predetermined moisture content of the target media, the aggregate energy including the received energy quantity resulting from the laser and an energy received from the drying apparatus.

10. The method of claim 7 wherein the laser is stationary, the stationary laser emitting the computed energy quantity based on a power of the laser and a duration of laser exposure as the conveyor draws the target media through the irradiation zone.

11. The method of claim 1 wherein refracting the laser further comprises beam shaping the laser for flattening an irradiance profile of the laser.

12. The method of claim 1 wherein focusing includes one or more of reflection, refraction, diffraction and absorption.

13. The method of claim 1 further comprising operating the laser at a wavelength of 960-985 nm.

14. The method of claim 1 further comprising operating the laser at a power between 4.5-50.0 kW.

15. The method of claim 1 further comprising:
receiving a signal from a sensor indicative of the laser energy received by the target media; and
directing, via a controller, an energy level delivered by the laser.

16. The method of claim 1 further comprising:
flowing a coolant adjacent the laser for cooling the laser and absorbing heat from the laser;
pumping the coolant through a heat exchange for heating air passing through the heat exchanger; and
directing the air from the heat exchanger to the target media.

17. A laser drying device, comprising:
a laser, the laser directed at a target media for drying;
a focusing element disposed between the laser and the target media for dispersing laser energy across the target media; and
a controller for powering the laser at a predetermined energy quantity for drying the target media.

18. The apparatus of claim 17, further comprising:
a complementary drying source adjacent the laser, the complementary drying source configured for a serial engagement with the target media; and
the controller further configured for powering the laser and the complementary drying source such that an aggregation of the laser energy and the complementary drying source completes the drying of the target media.
